(19) United States
(12) Patent Application Publication
(10) Pub. No.: US 2010/0241301 A1
(43) Pub. Date: Sep. 23, 2010

(54) Method of power management for plug-in hybrid and electric vehicle

(75) Inventor: Anthony An-Tao Yang, Surrey (CA)

Correspondence Address: Anthony An-Tao Yang, 16776 - 108 Ave., Surrey, BC, V4N 1M4, CA

(73) Assignees: Anthony An-Tao Yang, Surrey (CA); Aleees Eco Ark (Cayman) Co. LTD., Grand Cayman (KY)

(21) Appl. No.: 12/659,672

(22) Filed: Mar. 17, 2010

Related U.S. Application Data
(60) Provisional application No. 61/210,222, filed on Mar. 17, 2009.

(51) Int. Cl. G06F 7/00

(52) U.S. Cl. 701/29

(57) ABSTRACT

A system utilizes vehicle location, direction of travel, battery status, destination, and other data to provide control instruction and information to a plug-in hybrid electric vehicle, electric vehicle, or user.

### CROSS-REFERENCE TO RELATED APPLICATIONS

This application claims priority to U.S. application Ser. No. 61/210,222, filed on Mar. 17, 2009. The disclosure of the prior application is considered part of (and is incorporated by reference in) the disclosure of this application.

### BACKGROUND

As plug-in hybrid and electric debut, needs for replenishing electric energy arises.

In plug-in hybrid vehicles, both electricity and fossil fuel can be used to propel the vehicle, but minimizing the use of fossil fuel can have many befits such as lowering the cost and decrease emissions. If the battery level in plug-in hybrid vehicles are not managed in a particular manner, the user often arrive home, or a charge station, with a relatively high battery level; thus, the benefit of a plug-in hybrid diminishes greatly.

In electric vehicles, the battery is the only power source; a depleted battery would bring the vehicle to a halt. Before charge station and battery swap station are as fully implemented as gas station, fear of running out of electricity will hinder the sales of electric vehicle.

### OBJECTIVE

The primary objective is to provide a method of power management for plug-in hybrid and electric vehicles in which the use of fossil fuel is minimized.

It is also an objective to provide a method of power management for electric vehicle which prevents depletion of battery.

### SUMMARY

A method to alert user when an electric vehicle requires imminent charging or battery swap is provided.

A method to ensure maximum amount of electricity be charged into a plug-in hybrid vehicle is provided.

### DESCRIPTION OF THE DRAWING

FIGS. 1 to 3 show a flowchart of operation.

### DESCRIPTION

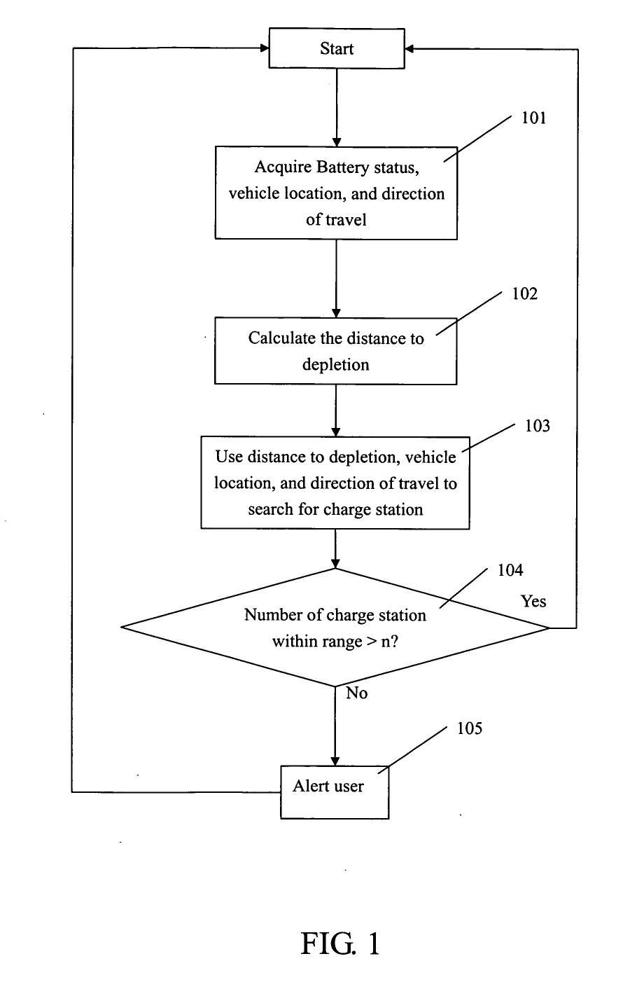

In a first embodiment consistent with the principles of the present invention, as shown in FIG. 1, a power management system capable of locating the vehicle, acquire battery status, providing mode control instructions to the vehicle, and data communication with a database is controlled by method hereafter. While an electric vehicle is in operation, the system will acquire battery status, vehicle location, and direction of travel 101. The battery level will be used to calculate the distance which vehicle can travel before battery depletion 102. The system than take vehicle location as the starting point, and use distance to depletion, and direction of travel to search for charge station within range 103. List of charge stations are acquired from the database via communication link. The charge stations that require a u-turn will not be considered unless it is the last charge station possible. The system may also filter out charge stations that are already full. If the vehicle is designed to cope with battery swap station, the system could show battery swap station as well. The system will then determine if the number of charge station within range are more than a predetermined number n 104. If the number of charge station within range is smaller then the predetermined number n, the user will be alerted 105. This control method can inform the user of an electric vehicle that there is a very limited charge station within range.

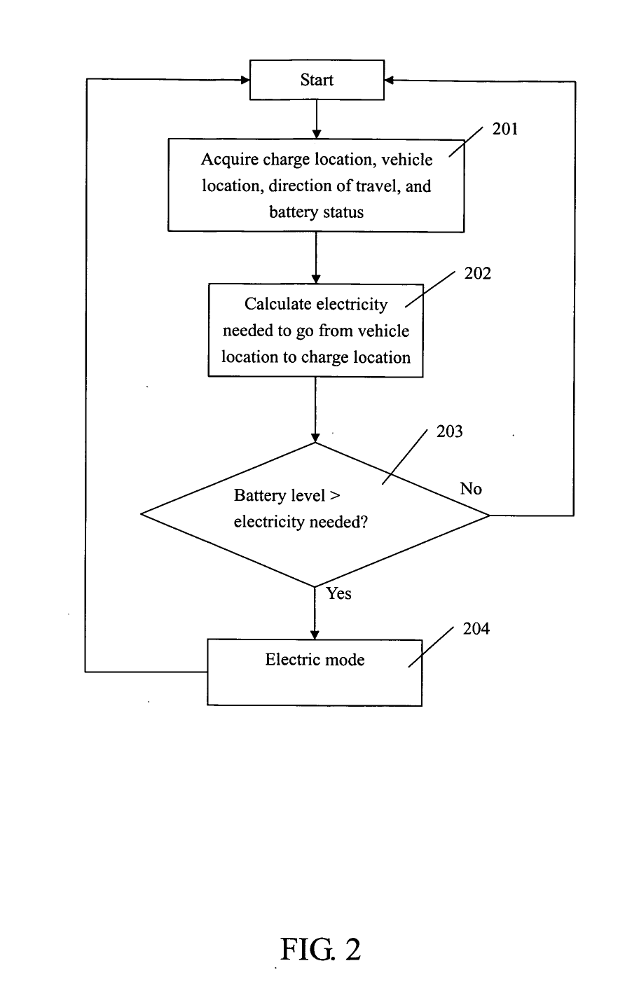

In a second embodiment consistent with the principles of the present invention, as shown in FIG. 2, a power management system capable of locating the vehicle, acquire battery status, providing mode control instructions to the vehicle, and data communication with a database is controlled by method hereafter. While a plug-in hybrid electric vehicle is in operation, the system will acquire a predetermined charge location, vehicle location, direction of travel, and battery status 201. The system then calculates electricity needed from the vehicle's current location to the charge location 202. The direction of travel is used to determine if the vehicle is driving towards or away from the charge location. The system will then compare if the battery level is higher then the electricity needed from the vehicle's current location to the charge position 203. If the battery level is higher than the electricity needed, the system will provide instruction to the vehicle to enter electric mode 204. This can ensure that the vehicle arrive the charge location with a near depleted battery, which the advantage of a plug-in hybrid can be maximized. A button can be provided on the dash of the vehicle which when user press it, the vehicle will automatically record the current location as a useable charge location.

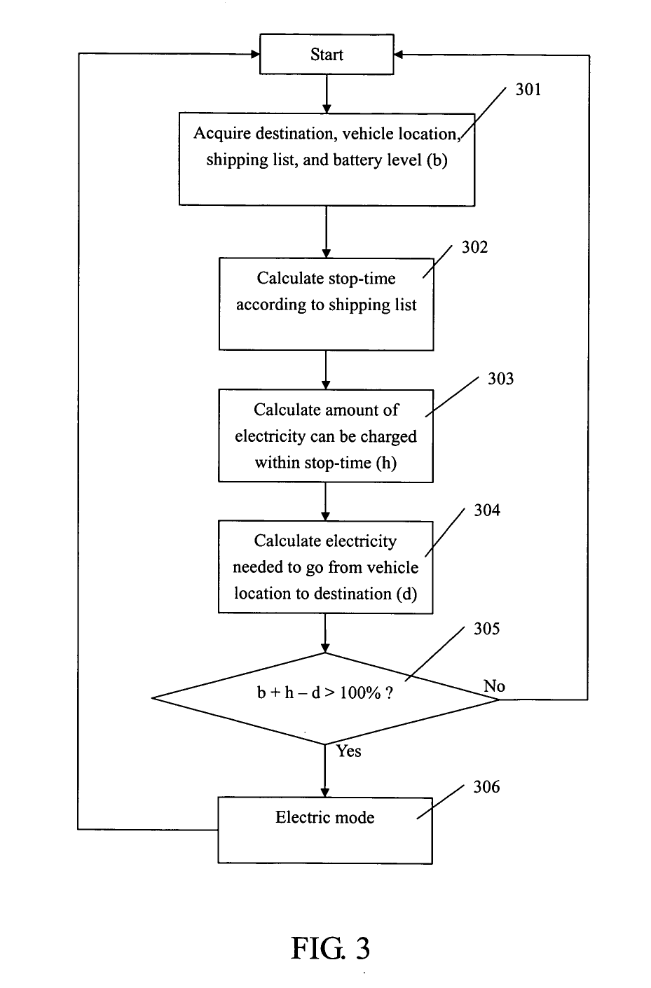

In a third embodiment consistent with the principles of the present invention, as shown in FIG. 3, a power management system capable of locating the vehicle, acquire battery status, providing mode control instructions to the vehicle, and data communication with a database is controlled by method hereafter. While a plug-in hybrid electric vehicle is in shipping operation with known shipping list and destination, the system will acquire destinations and shipping lists from data base via data communication and acquire vehicle location and battery level from onboard unit 301. The system will calculate the stop-time at above mentioned destination according to the shipping-list 302. Time required for delivery for each item on the shipping list is to be provided by the database. The system will calculate how much electricity can be charged within the previously calculated stop-time 303. The system will also calculate the electricity needed from the vehicle's current location to the destination 304. The system then determine if the current battery level plus the electricity can be charged with in stop-time less the electricity needed to travel from current location to destination exceeds the total capacity of the battery 305. If the electricity calculated exceeds the total capacity of the battery, the system will instruct the vehicle to enter electric mode 306. This method will ensure maximum amount of electricity be charge while the vehicle depart from each destination with a full battery.

What is claimed is:

1. A method comprising:
a) acquire vehicle current location;
b) acquire battery status;
c) calculate distance to depletion according to said battery status;
d) utilizing said vehicle current location and said distance to depletion to search for charge stations within range;
e) determine if number of charge stations within range is smaller than a predetermined number; and,
f) alert user if said number of charge stations within range is smaller than said predetermined number.

2. A method comprising:
a) acquire charge location;
b) acquire current vehicle location;
c) acquire battery level;
d) calculate electricity needed to travel from said current vehicle location to said charge location;
e) determine if said battery level is higher than the said electricity needed to travel from said current vehicle location to said charge location; and,
f) instructs the vehicle to enter electric mode if said battery level is higher than the said electricity needed to travel from said current vehicle location to said charge location.

3. A method comprising:
a) acquire destination;
b) acquire current vehicle location;
c) acquire shipping list;
d) acquire battery level;
e) calculate stop-time and destination according to said shipping list;
f) calculate amount of electricity can be charged within said stop-time;
g) calculate electricity needed to go from current vehicle location to said destination;
h) determine if the sum of said battery level and said electricity can be charged within said stop-time less said electricity needed to go from current vehicle location to said destination is in excess of total battery capacity; and,
i) instructs the vehicle to enter electric mode if said sum of said battery level and said electricity can be charged within said stop-time less said electricity needed to go from current vehicle location to said destination is in excess of total battery capacity.

4. A method as defined in claim 1 further comprising:
a) acquire direction of travel; and,
b) subtract number of charge stations that deviates from the said direction of travel from the said number of charge stations within range.

5. A method as defined in claim 1 wherein said charge station includes battery swap station if the vehicle utilizing said method as defined in claim 1 in a type of vehicle that utilizes battery swap station.

6. A method as defined in claim 2 further comprising recording said current vehicle location as a charge location when user instructs.
